(19) United States
(12) Patent Application Publication
(10) Pub. No.: US 2026/0292356 A1
(43) Pub. Date: Sep. 24, 2026

(54) LIGHT SOURCE DISCRIMINATION DEVICE, LIGHT SOURCE DISCRIMINATION METHOD, AND NON-TRANSITORY RECORDING MEDIUM

(71) Applicant: CASIO COMPUTER CO., LTD., Tokyo (JP)

(72) Inventor: Naotomo MIYAMOTO, Tokyo (JP)

(73) Assignee: CASIO COMPUTER CO., LTD., Tokyo (JP)

(21) Appl. No.: 19/438,419

(22) Filed: Dec. 31, 2025

(30) Foreign Application Priority Data
Mar. 24, 2025 (JP) 2025-048311

(51) Int. Cl. H04N 23/76; H04N 23/84

(52) U.S. Cl. CPC H04N 23/76; H04N 23/843; H04N 2209/045

(57) ABSTRACT

A light source discrimination device includes at least one processor discriminating whether each of a plurality of light source images included in a Bayer image obtained by imaging a predetermined area by a camera indicates a first light source serving as a transmitter for visible light communication and undergoing change in color with a predetermined change pattern or a second light source serving as a white light source installed for lighting. The at least one processor generates a reduced image for each of the light source images by averaging brightness values of pixels for each unit of pixels in which a red component, a blue component, and a green component are included at a ratio of 1:1:2, and discriminates whether each of the plurality of light source images indicates the first light source or the second light source, based on magnitude of a brightness value in the reduced image.

### CROSS-REFERENCE TO RELATED APPLICATIONS

This application is based upon and claims the benefit of priority under 35 USC 119 of Japanese Patent Application No. 2025-048311, filed on Mar. 24, 2025, the entire disclosure of which, including the description, claims, drawings, and abstract, is incorporated herein by reference in its entirety.

### FIELD OF THE INVENTION

This application relates to a light source discrimination device, a light source discrimination method, and a non-transitory recording medium.

### BACKGROUND OF THE INVENTION

Unexamined Japanese Patent Application Publication No. 2005-315746 describes a technology for detecting an object included in an imaged image, using visible light and performing position calculation of the imaged object and a moving body that performs the imaging.

### SUMMARY OF THE INVENTION

One aspect of a light source discrimination device according to the present disclosure includes at least one processor that determines whether each of a plurality of light source images included in a Bayer image obtained by imaging a predetermined area by a camera indicates a first light source that serves as a transmitter for visible light communication and that undergoes change in color with a predetermined change pattern or a second light source that serves as a white light source installed for lighting. The at least one processor generates a reduced image for each of the light source images by averaging brightness values of pixels for each unit of pixels in which a red component, a blue component, and a green component are included at a ratio of 1:1:2, and discriminates whether each of the plurality of light source images indicates the first light source or the second light source, based on magnitudes of a brightness value in the reduced image.

### BRIEF DESCRIPTION OF DRAWINGS

A more complete understanding of this application can be obtained when the following detailed description is considered in conjunction with the following drawings, in which:

FIG. 1 is a diagram describing a position calculation system according to an embodiment;

FIG. 2 is a diagram describing a position calculation device and a terminal according to the embodiment;

FIG. 3 is a diagram illustrating an example of a Bayer array in a filter of an image sensor in a camera of the position calculation device according to the embodiment and is a diagram describing reduction;

FIG. 4A is a diagram describing a state of blue light before imaging;

FIG. 4B is a diagram describing a state of a Bayer image of blue light before reduction; and

FIG. 5 is a flowchart illustrating a flow of position calculation processing according to the embodiment.

### DETAILED DESCRIPTION OF THE INVENTION

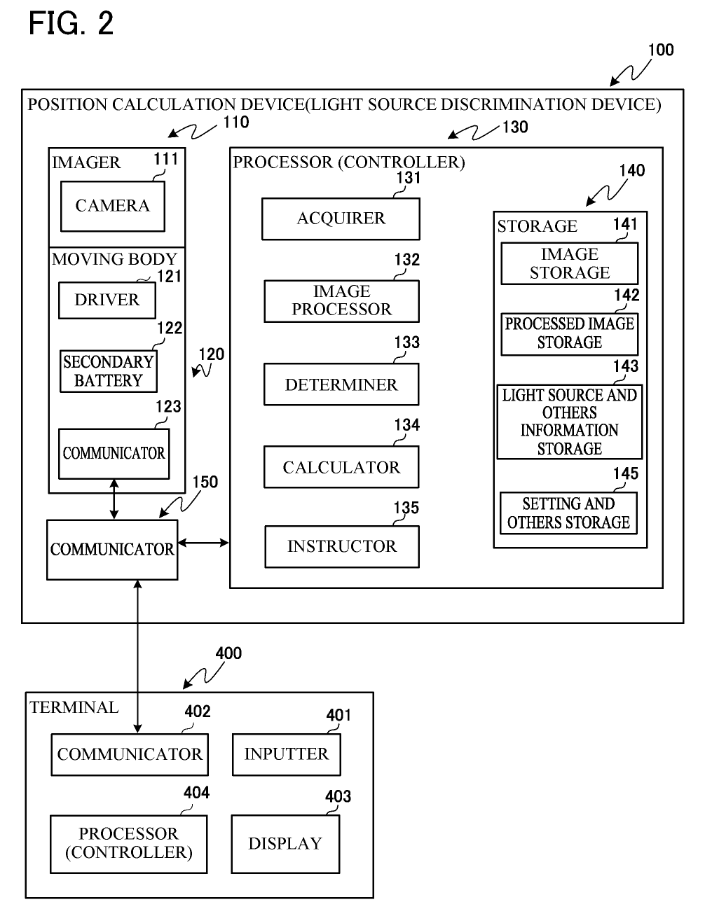

An embodiment of the present disclosure is described below with reference to the drawings. Note that the same or corresponding parts in the drawings are designated by the same reference numerals. A position calculation system 1 according to the embodiment includes a position calculation device (light source discrimination device) 100 that performs positioning of a self-position of a light source (a first light source) 200 or the like, using visible light communication, the light source 200 that is communicable with the position calculation device 100 through the visible light communication, an indoor light (a second light source) 300 that is a light inside a building B, and a terminal 400 that operates the position calculation device 100. The position calculation device 100 is a moving camera-type device that is mainly used in a warehouse or a factory. As illustrated in FIG. 2, the position calculation device 100 is a device including an imager 110 that images the light source 200, the indoor light 300, and the like, a moving body 120 that moves the imager 110, a processor 130 that performs processing of an imaged image and the like, and a communicator 150 that communicates with the terminal 400. Note that the light source 200 and the indoor light 300 are collectively referred to as a light emitting device in some cases.

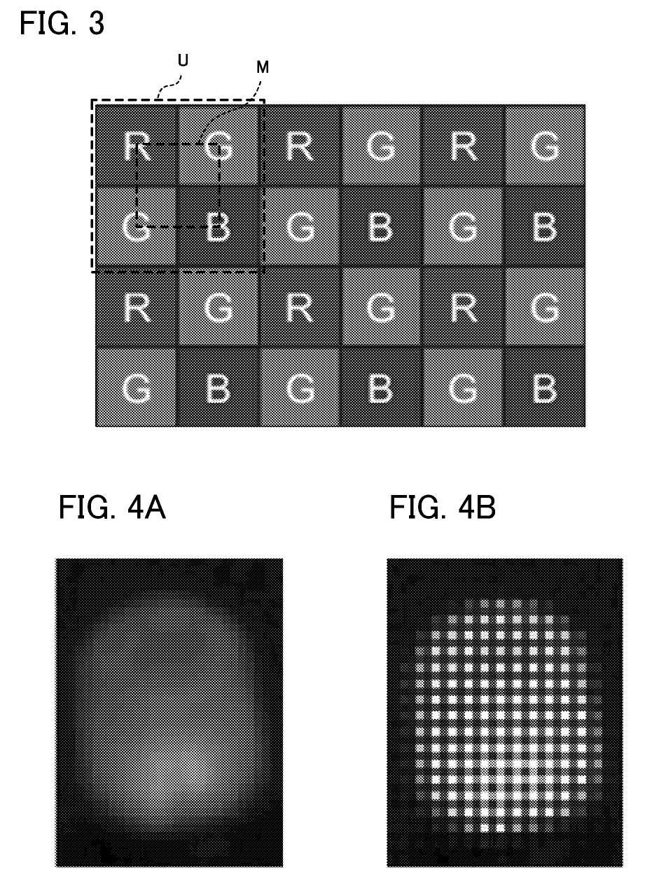

The imager 110 has two cameras 111 that image the light source 200 and the indoor light 300 and generates a Bayer image. Each of the cameras 111 is a receiver in visible light communication with the light source 200, and is, for example, a single chip color camera with high definition (HD) resolution equipped with a lens with a 90-degree view angle. An image sensor of the camera 111 uses, for example, a filter that employs an RGGB Bayer array, as illustrated in FIG. 3. Each of the two cameras 111 is mounted on the moving body 120.

As illustrated in FIG. 2, the moving body 120 includes a driver 121 that drives the moving body 120 to operate, a secondary battery 122 that supplies power to the moving body 120, and a communicator 123 that communicates with the communicator 150 of a main body of the position calculation device 100. The driver 121 drives the moving body 120 to move in accordance with an instruction from an instructor 135 to be described later, and also changes a posture of the moving body 120 in such a way that each camera 111 points in an instructed direction. The communicator 123 includes wireless communication modules conforming to a wireless communication standard, such as wireless local area network (LAN) and Bluetooth (registered trademark). The moving body 120 receives an instruction or the like from the terminal 400 via the communicators 150 and 123 and moves within a position detection area P of approximately 50 meter square inside the building B by causing the driver 121 to operate. The communicator 123 transmits a Bayer image imaged by a camera 111 to the main body of the position calculation device 100 via the communicator 150.

The processor 130 includes a central processing unit (CPU) and a storage 140. The storage 140 includes a read only memory (ROM) and a random access memory (RAM). The ROM includes a non-volatile memory, such as flash memory, and stores a program, Bayer image data, and the like for the processor 130 to achieve various types of functions. The RAM includes a volatile memory and is used as a working area for the processor 130 to execute a program to perform various types of processing. The processor 130 functions as an acquirer 131, an image processor 132, a discriminator 133, a calculator 134, and the instructor 135 by retrieving a program stored in the storage 140 and executing the retrieved program on the RAM. The processor 130 may also be referred to as "controller" or "processor". The acquirer 131 acquires data of a Bayer image imaged by the imager 110 via the communicators 123 and 150 and stores the acquired data in an image storage 141. The image processor 132 reduces the Bayer image stored in the image storage 141 at a predetermined reduction ratio and stores data of the reduced Bayer image in a processed image storage 142. The reduction does not mean to merely reduce size of a Bayer image, and in a case where, for example, the size of a Bayer image is reduced by half, the image processor 132 calculates a mean value of pixel values for each unit (area) U of four pixels composed of 2×2 RGGB pixels and sets the mean value as a pixel value of a predetermined pixel at a pixel M into which the unit U of four pixels is reduced, as illustrated in FIG. 3. In other words, the image processor 132 generates a reduced image for each of the plurality of light source images by averaging brightness values of pixels for each unit of pixels in which a red component, a blue component, and a green component are included at a ratio of 1: 1:2. The reduction means the image processor 132 performing this calculation across the overall Bayer image and generating a reduced Bayer image (a reduced image) by collecting the pixels M into an image, and does not include pixel thinning processing. In a case where a reduction rate is less than 1 and greater than or equal to 1/2, the image processor 132 first reduces the Bayer image by half and subsequently enlarges the reduced Bayer image to adjust the rate. In a case where a Bayer image is reduced to 1/4, the image processor 132 reduces the Bayer image by, as with the case of 1/2 reduction, taking a mean value of pixel values for each 4×4=16 pixels. In a case where the reduction rate is less than 1/2 and greater than or equal to 1/4, the image processor 132 first reduces the Bayer image to 1/4 and subsequently enlarges the reduced Bayer image to adjust the rate. For a rate smaller than 1/4, the image processor 132 can also perform calculation matching the reduction rate using a similar process. Note that reduction may be achieved only by calculating pixel values without reducing size of the image. The discriminator 133 discriminates a pixel that has a pixel value exceeding a predetermined threshold value in the reduced Bayer image. In addition, in a case where there exists a pixel having a pixel value exceeding the predetermined threshold value, the discriminator 133 discriminates whether or not the pixel indicates white light from an indoor light 300 or a light source 200, based on whether or not a pixel value of a pixel within a predetermined range close to the pixel is also a pixel value exceeding the predetermined threshold value, and stores a discrimination result in a light source and others information storage 143. In a case where imaged light is not white light, for example, in a case where blue light with a vertically long elliptical shape as illustrated in FIG. 4A is imaged, the imaged Bayer image includes a checkered pattern of high brightness pixels (B pixels of the RGB pixels) as illustrated in FIG. 4B, and reducing the image generates a reduced Bayer image with a brightness of the overall illumination lower than that in FIG. 4A. In contrast, in a case where white light is imaged, a Bayer image with a high pixel brightness across the overall illumination is generated, the reduced Bayer image likewise has a high pixel brightness across the overall illumination, and the discriminator 133 can thus easily discriminate that the light is white light. In a specific example of pixel values, in the case of blue light, a pixel value at a position in the filter corresponding to a B pixel is 255, pixel values at positions in the filter corresponding to R and G pixels that constitute a unit with a B pixel are 0, and a pixel value of a pixel into which a unit of RGGB pixels is reduced by half is given by (255+0+0+0)/4=63. In the case of white light, since the pixel value at any of positions corresponding to B, G, and R pixels becomes 255, the pixel value after reduction is given by (255+255+255+255)/4=255. In a case of red light, a pixel value after reduction is 63, and in a case of green light, since the number of filter elements corresponding to G pixels is twice the number of filter elements corresponding to B pixels or R pixels, a pixel value after reduction is 127. Therefore, in a case where the predetermined threshold value is set to approximately 240, white light can be detected from the reduced Bayer image. Further, the discriminator 133 discriminates existence or nonexistence of a light source 200 from a Bayer image imaged during a predetermined period and stores a discrimination result in the light source and others information storage 143. Determination of the existence or nonexistence of a light source 200 is performed by detecting blinking in a predetermined pattern that is characteristic of the light source 200 from Bayer images imaged during a predetermined period. The calculator 134 calculate, using coordinates of the light source 200 and the indoor light 300 stored in the light source and others information storage 143, positions and the like of the light source 200 and the moving body 120 and store the calculated positions and the like in the light source and others information storage 143. The instructor 135 instructs the moving body 120 to operate, based on a program stored in the storage 140 to cause the moving body 120 to operate or based on an instruction from a user received by the terminal 400. In addition, the storage 140 also includes a setting and others storage 145 in which the above-described threshold value, the above-described program to cause the moving body 120 to operate, a pre-measured position (coordinates) of the indoor light 300, and the numbers of light sources 200 and indoor lights 300 that are required for position calculation processing to be described later are stored.

The communicator 150 includes wireless communication modules conforming to a wireless communication standard, such as wireless local area network (LAN) and Bluetooth (registered trademark), as with the communicator 123. The communicator 150 communicates with the terminal 400 and the communicator 123 of the moving body 120. In addition, the communicator 150 is capable of accessing a network such as the Internet.

The light source 200 is an LED ceiling light mounted on a ceiling of the building B, and two light sources 200 are installed. The light sources 200 are light sources that are newly installed in the building B, for which positioning has not been performed yet, and the positions (coordinates) of which are thus unknown. Each of the light sources 200 is a transmitter that transmits a signal in visible light communication with the position calculation device 100. Each of the light sources 200, for example, has a size of a diameter of 10 cm and a height of 10 cm and approximately one million combinations of color change patterns to be transmitted as signals (the light source 200 blinks once every 0.1 seconds (10 fps) and the number of blinks is 24). In addition, since each of the light sources 200 performs turning on and off that include a predetermined blinking pattern characteristic of the light source 200, the discriminator 133 is capable of detecting the light source 200, based on the predetermined blinking pattern. Since the light sources 200 transmit emission colors of the LED lights as signals as described above, the light sources 200 are capable of coping with an environment in which use of radio waves is restricted, such as a place where there is interference of radio waves, shielding of radio waves, or restrictions due to information security reasons, and a situation in which a communication cable cannot be installed.

Each of the indoor lights 300 is an LED ceiling light that is generally used in a warehouse, a factory, or the like, that is mounted on the ceiling of the building B, and that turns on white light. The number, performance, and an arrangement of indoor lights 300 are adjusted in such a way that an average illuminance on a floor surface is approximately 500 lx or more. As a result, although details are described later, the indoor lights 300 are capable of acting as complementary lights to the light sources 200. Note that a ceiling light refers to a light mounted on or around the ceiling. In addition, positions (coordinates) at which the indoor lights 300 are mounted are measured by a total station or the like in advance, and the positions are stored in the light source and others information storage 143 to be described later.

The terminal 400 includes an inputter 401 that accepts user input, a communicator 402 that communicates with the communicator 150 and the like, a display 403 that displays information and the like acquired via the communicator 402 to the user, a processor 404, and the like. The terminal 400 is capable of operating the moving body 120 by operation input to the inputter 401 by the user. The communicator 402 includes wireless communication modules conforming to a wireless communication standard, such as wireless LAN and Bluetooth (registered trademark), as with the communicators 123 and 150, and communicates with the communicator 150. The terminal 400 collects position information and the like of the moving body 120, other mobile equipment, and the like acquired from the position calculation device 100, via the communicators 402 and 150, and the user uses the collected information for a higher-level system, such as a flow line analysis system and a position management system. The user, for example, analyzes a bottleneck from a wasteful operation flow line, a stagnation point, or the like of mobile equipment and uses the analyzed bottleneck in layout change in a warehouse or a factory and improvement in a work process.

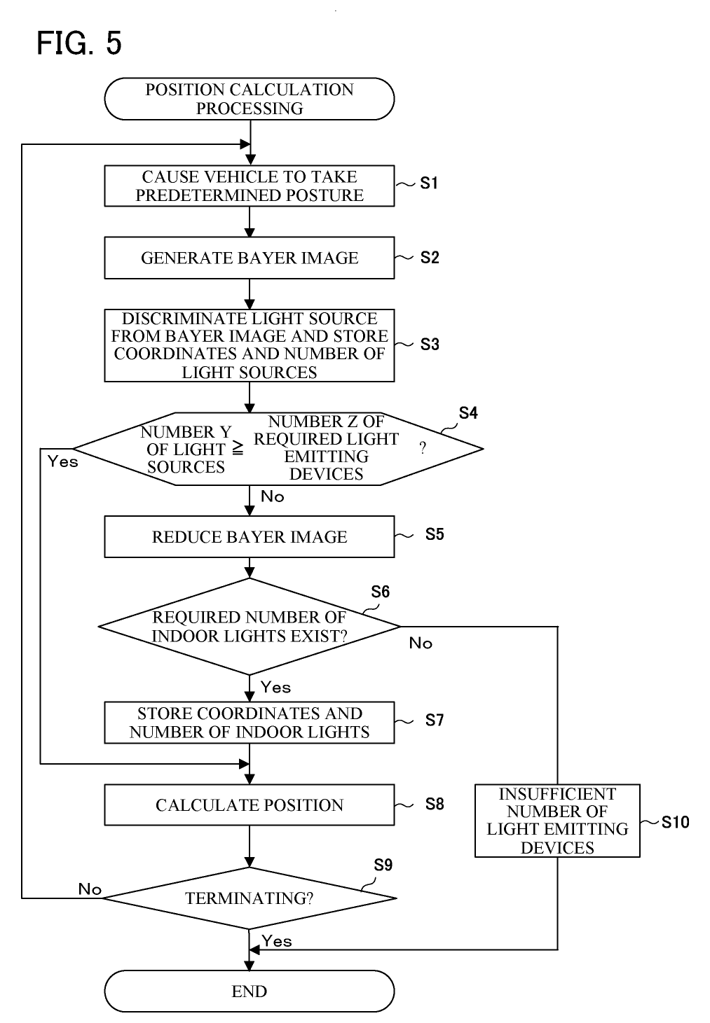

Next, the position calculation processing executed by the position calculation device 100 of the position calculation system 1 having the configuration described above is described with reference to FIG. 5. The position calculation processing illustrated in FIG. 5 is an example of a position calculation method (light source discrimination method). The position calculation processing is processing of calculating positions of the moving body 120 and the like by using not only a light source 200 prepared for the present system but also a general indoor light 300 installed in a warehouse or a factory. In other words, the position calculation processing that the present system executes allows position calculation to be performed with high accuracy despite fewer light sources 200 being installed than generally required.

First, in response to the position calculation processing being started, the instructor 135 instructs the moving body 120 to take a predetermined posture (position and direction) in accordance with an instruction that the user inputs or in accordance with the program stored in the setting and others storage 145 (step S1). After the moving body 120 has taken the predetermined posture, the imager 110 performs imaging for a predetermined period and generates a Bayer image (step S2). The discriminator 133 discriminates a light source 200 from the Bayer image imaged during the predetermined period, discriminates the number Y of light sources 200, and stores discrimination results in the light source and others information storage 143 in association with coordinates of the light sources 200 (step S3). The discriminator 133 compares the number Y of light sources 200 included in the Bayer image with the number Z of light emitting devices required for position calculation processing, and discriminates whether or not Y≥Z holds (step S4). In a case where Y≥Z holds (step S4: Yes), the process proceeds to step S8 (performs the position calculation using only the light sources 200). In a case where Y≥Z does not hold (step S4: No), the process proceeds to step S5 (performs the position calculation using the light sources 200 and the indoor lights 300).

The image processor 132 reduces the Bayer image to an image of a predetermined size (by half in the present embodiment) and generates a reduced Bayer image. On this occasion, a pixel at a predetermined point has a pixel value that is a mean value of pixel values of a unit U of four pixels composed of 2×2 RGGB pixels, as described above (step S5). The discriminator 133 discriminates, to discriminate an area corresponding to white color in a color image generated by de-mosaicking the reduced Bayer image, whether or not, in the reduced Bayer image, there are pixels having pixel values exceeding a predetermined threshold value, for example, a pixel value of 240, and whether or not such pixels are located close to one another and shape a required number (obtained by subtracting the number Y of the light sources 200 from the number Z of required light emitting devices) of areas of a predetermined size and shape, for example, circular or elliptical shapes including 25 pixels or more, in the Bayer image (step S6). In a case where there are pixels having pixel values exceeding the pixel value of 240 and such pixels are located close to one another and shape areas of a certain size within the Bayer image (step S6: Yes), the discriminator 133 discriminates the areas to be the indoor lights 300 and stores the number of the indoor lights 300 in the light source and others information storage 143 in association with the coordinates of the indoor lights 300 (step S7). In a case where there are no pixel having a pixel value exceeding the pixel value of 240, in a case where although there is a pixel having a pixel value exceeding the pixel value of 240, such pixels are not located close to one another or do not shape an area of a certain size within the Bayer image, or in a case where although there is a pixel having a pixel value exceeding the pixel value of 240 and such pixels are located close to one another and shape an area of a certain size within the Bayer image, the number of such areas does not reach the required number (step S6: No), the discriminator 133 discriminates that a required number of light emitting devices for position calculation are not found and displays a message indicating insufficiency of light emitting devices on the display 403 of the terminal 400 to notify the user of the insufficiency (step S10), and terminates the position calculation processing. The calculator 134 calculates the positions of the light sources 200, the position of the moving body 120, or the like, using the coordinates of the light sources 200 and the indoor lights 300 (in a case where the process proceeded from step S8, using only the coordinates of the light sources 200) stored in the light source and others information storage 143 (step S8). For the calculation of positions, for example, a method described in paragraphs 0042 to 0062 in the description, FIG. 7, and the like in Unexamined Japanese Patent Application Publication No. 2023-43631 is used. Another calculation method may be used. In a case where the position calculation is to be terminated (step S9: Yes), the position calculation processing is terminated, and in a case where the position calculation is not to be terminated (step S9: No), the process returns to step S1.

As described in the foregoing, since the position calculation system 1 according to the present embodiment performs the detection of white light from an indoor light 300 and a light source 200 by directly processing a Bayer image, a computational cost of de-mosaicking and a computational cost of white light detection from an RGB image or the like can be eliminated. Therefore, in the position calculation system 1, the position calculation can be performed at low cost. In addition, since an indoor light 300 such as an existing white light is also used, it is possible to minimize the number of light sources 200 and it is also possible to not only achieve a reduction in cost but also maintain calculation precision, or in a case where more indoor lights 300 than a required minimum number are used for calculation, it is possible to improve accuracy.

In other words, the position calculation system 1 according to the present embodiment functions as a light source discrimination device. In addition, the light source discrimination device includes at least one processor that discriminates whether each of a plurality of light source images included in a Bayer image obtained by imaging a predetermined area by a camera indicates a first light source that serves as a transmitter for visible light communication and that undergoes change in color with a predetermined change pattern or a second light source that serves as a white light source installed for lighting. Further, the at least one processor generates a reduced image for each of the plurality of light source images by averaging brightness values of pixels for each unit of pixels in which a red component, a blue component, and a green component are included at a ratio of 1:1:2, and discriminates whether each of the plurality of light source images indicates the first light source or the second light source, based on magnitude of a brightness value in the reduced image.

In addition, the at least one processor discriminates that the light source image indicates the second light source in a case where a brightness value in the reduced image is greater than a predetermined threshold value, and discriminates that the light source image indicates the first light source in a case where a brightness value in the reduced image is less than the predetermined threshold value. Specifically, the at least one processor detects an area in which pixels having brightness values greater than or equal to a predetermined value are located close to one another in a predetermined shape as an area of the light source image in the Bayer image. In addition, the at least one processor discriminates that the light source image indicates the second light source in a case where a mean value of brightness values in the reduced image corresponding to an area of the light source image is greater than a predetermined threshold value, and discriminates that the light source image indicates the first light source in a case where a mean value of brightness values in the reduced image corresponding to an area of the light source image is less than the predetermined threshold value.

Although the embodiment of the present disclosure is described above, the above-described embodiment is an example, and the scope of application of the present disclosure is not limited thereto. That is, various applications of the embodiment of the present disclosure are possible, and all possible embodiments are included in the scope of the present disclosure. For example, although in the above-described embodiment, the position calculation device 100 includes the imager 110 and the moving body 120, it may be configured such that a commercially available moving body equipped with a camera transmits an imaged image to a position calculation device 100 that does not have an imager. In addition, although the imager 110 of the position calculation device 100 is a mobile type device, the imager 110 may be a device integrated with the main body of the position calculation device 100 or a fixed type device that is fixed at a place located away from the main body of the position calculation device 100.

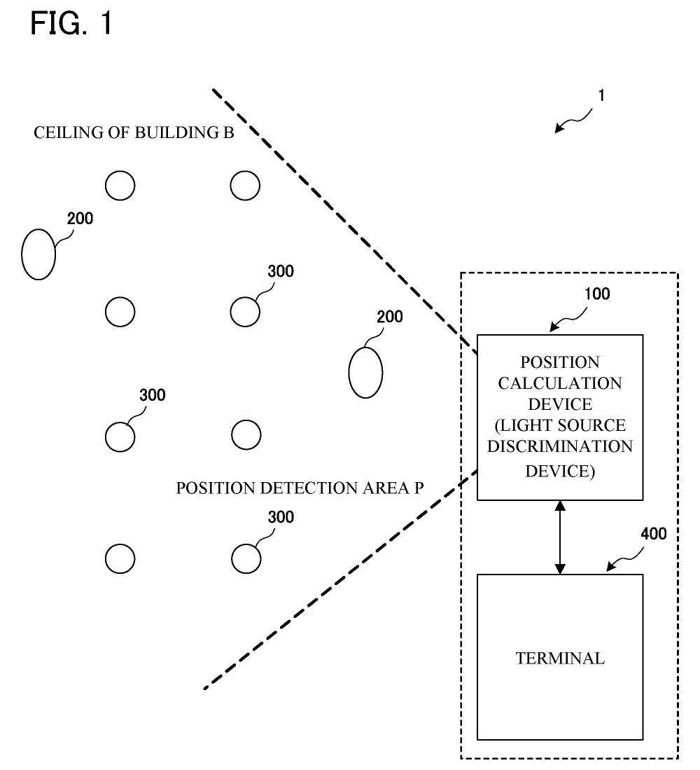

Although in the above-described embodiment, as illustrated in FIG. 1, there are two light sources 200 and eight indoor lights 300, the number, positions, and the like of the light sources 200 and the indoor lights 300 may be changed according to area of the position detection area P where positioning is performed by the position calculation system 1, precision required for a self-position, or the like.

Although in the above-described embodiment, the light emitting devices are the light sources 200 and the indoor lights 300, the light emitting devices may also include another type of light in addition to the light sources 200 and the indoor lights 300, or the light sources 200 and a light attached to a wall surface, equipment, an operator, or the like may serve as the light emitting devices. Various combinations of light sources may constitute the light emitting devices as long as the combination include a light source 200.

Although in the above-described embodiment, the predetermined shape is one of a circle, an ellipse, and a parallelogram, another shape may be added or the number of shapes may be reduced. In addition, although the predetermined size is set to 25 pixels, another value may be set according to, for example, distance between the imager 110 and the light sources 200 or the indoor lights 300, required precision, or the like.

Although in the above-described embodiment, the positions of the light sources 200 are calculated, it may, for example, be configured to calculate the position of the imager 110 after calculating the positions of the light sources 200. In addition, it may be configured to correct the positions of the indoor lights 300 by comparing the positions with the coordinates stored in the light source and others information storage 143. Since the positions of the light sources 200 also sometimes change due to vibration or loosening of fittings, the positions may be recalculated after the initial calculation.

Although in the above-described embodiment, the position calculation device 100 and the terminal 400 are separate devices, the position calculation device 100 and the terminal 400 may be integrated.

Although in the embodiment described above, the image sensor of the camera 111 uses a filter employing an RGGB Bayer array, the filter may also be a filter employing a GRGB, GBRG, or BGGR Bayer array.

In addition, the functions of the position calculation device 100 can be implemented by a computer such as a general personal computer (PC) or the like. Specifically, in the above-described embodiment, the description is made assuming that the program for the position calculation processing performed by the position calculation device 100 is stored in advance in the ROM of the storage 140. However, it is also possible to configure a computer that can achieve the above-described functions by storing the program in a non-transitory computer-readable recording mediums, such as a flexible disk, a compact disc read only memory (CD-ROM), a digital versatile disc (DVD), and a magneto-optical disc (MO), distributing the non-transitory computer-readable recording medium, and reading in and installing the program in a computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A light source discrimination device, comprising
at least one processor that discriminates whether each of a plurality of light source images included in a Bayer image obtained by imaging a predetermined area by a camera indicates a first light source that serves as a transmitter for visible light communication and that undergoes change in color with a predetermined change pattern or a second light source that serves as a white light source installed for lighting,
wherein the at least one processor
generates a reduced image for each of the plurality of light source images by averaging brightness values of pixels for each unit of pixels in which a red component, a blue component, and a green component are included at a ratio of 1: 1:2, and
discriminates whether each of the plurality of light source images indicates the first light source or the second light source, based on magnitude of a brightness value in the reduced image.

2. The light source discrimination device according to claim 1, wherein
the at least one processor
discriminates that the light source image indicates the second light source in a case where a brightness value in the reduced image is greater than a predetermined threshold value, and
discriminates that the light source image indicates the first light source in a case where a brightness value in the reduced image is less than the predetermined threshold value.

3. The light source discrimination device according to claim 1, wherein the Bayer image is an image obtained by imaging the plurality of light sources installed on a ceiling at a predetermined height.

4. The light source discrimination device according to claim 1, wherein
the at least one processor
detects an area in which pixels having brightness values greater than or equal to a predetermined value are located close to one another in a predetermined shape as an area of the light source image in the Bayer image.

5. The light source discrimination device according to claim 4, wherein
the at least one processor
discriminates that the light source image indicates the second light source in a case where a mean value of brightness values in the reduced image corresponding to an area of the light source image is greater than a predetermined threshold value, and
discriminates that the light source image indicates the first light source in a case where a mean value of brightness values in the reduced image corresponding to an area of the light source image is less than the predetermined threshold value.

6. The light source discrimination device according to claim 4, wherein the predetermined shape is one of a circle, an ellipse, and a parallelogram.

7. The light source discrimination device according to claim 1, wherein the camera is installed on a moving body.

8. A light source discrimination method, comprising:
acquiring a Bayer image including a plurality of light source images by imaging a predetermined area by a camera; and
discriminating whether each of the plurality of light source images included in the Bayer image acquired in the acquiring indicates a first light source that serves as a transmitter for visible light communication and that undergoes change in color with a predetermined change pattern or a second light source that serves as a white light source installed for lighting,
wherein the discriminating
generates a reduced image for each of the plurality of light source images by averaging brightness values of pixels for each set of pixels in which a red component, a blue component, and a green component are included at a ratio of 1:1:2, and
discriminates whether each of the plurality of light source images indicates the first light source or the second light source, based on magnitude of a brightness value in the reduced image.

9. The light source discrimination method according to claim 8, wherein
the discriminating
discriminates that the light source image indicates the second light source in a case where a brightness value in the reduced image is greater than a predetermined threshold value, and
discriminates that the light source image indicates the first light source in a case where a brightness value in the reduced image is less than the predetermined threshold value.

10. The light source discrimination method according to claim 8, wherein
the acquiring
acquires the Bayer image by imaging a plurality of light sources installed on a ceiling at a predetermined height.

11. The light source discrimination method according to claim 8, wherein
the discriminating
detects an area in which pixels having brightness values greater than or equal to a predetermined value are located close to one another in a predetermined shape as an area of the light source image in the Bayer image.

12. The light source discrimination method according to claim 11, wherein
the discriminating
discriminates that the light source image indicates the second light source in a case where a mean value of brightness values in the reduced image corresponding to an area of the light source image is greater than a predetermined threshold value, and
discriminates that the light source image indicates the first light source in a case where a mean value of brightness values in the reduced image corresponding to an area of the light source image is less than the predetermined threshold value.

13. The light source discrimination method according to claim 11, wherein the predetermined shape is one of a circle, an ellipse, and a parallelogram.

14. The light source discrimination method according to claim 8, wherein the camera is installed on a moving body.

15. A non-transitory recording medium storing a computer-readable program, the program causing the computer to execute processing comprising:
acquiring a Bayer image including a plurality of light source images by imaging a predetermined area by a camera; and
discriminating whether each of the plurality of light source images included in the Bayer image acquired in the acquiring indicates a first light source that serves as a transmitter for visible light communication and that undergoes change in color with a predetermined change pattern or a second light source that serves as a white light source installed for lighting,
wherein the discriminating
generates a reduced image for each of the plurality of light source images by averaging brightness values of pixels for each set of pixels in which a red component, a blue component, and a green component are included at a ratio of 1:1:2, and
discriminates whether each of the plurality of light source images indicates the first light source or the second light source, based on magnitude of a brightness value in the reduced image.

16. The non-transitory recording medium according to claim 15, wherein
the discriminating
discriminates that the light source image indicates the second light source in a case where a brightness value in the reduced image is greater than a predetermined threshold value, and
discriminates that the light source image indicates the first light source in a case where a brightness value in the reduced image is less than the predetermined threshold value.

17. The non-transitory recording medium according to claim 15, wherein
the acquiring
acquires the Bayer image by imaging a plurality of light sources installed on a ceiling at a predetermined height.

18. The non-transitory recording medium according to claim 15, wherein
the discriminating
detects an area in which pixels having brightness values greater than or equal to a predetermined value are located close to one another in a predetermined shape as an area of the light source image in the Bayer image.

19. The non-transitory recording medium according to claim 18, wherein
the discriminating
discriminates that the light source image indicates the second light source in a case where a mean value of brightness values in the reduced image corresponding to an area of the light source image is greater than a predetermined threshold value, and
discriminates that the light source image indicates the first light source in a case where a mean value of brightness values in the reduced image corresponding to an area of the light source image is less than the predetermined threshold value.

20. The non-transitory recording medium according to claim 18, wherein the predetermined shape is one of a circle, an ellipse, and a parallelogram.
